(19) United States
(12) Patent Application Publication
(10) Pub. No.: US 2012/0212862 A1
(43) Pub. Date: Aug. 23, 2012

(54) METHOD AND DEVICE FOR LIMITING SECONDARY ARC CURRENT OF EXTRA-HIGH VOLTAGE/ULTRA-HIGH VOLTAGE DOUBLE CIRCUIT LINES ON THE SAME TOWER

(75) Inventors: Liangeng Ban, Beijing (CN); Jiming Lin, Beijing (CN); Zutao Xiang, Beijing (CN); Bin Han, Beijing (CN); Xiaogang Wang, Beijing (CN); Xiaotong Wang, Beijing (CN); Ruihua Song, Beijing (CN); Hongtao Liu, Beijing (CN); Bin Zheng, Beijing (CN)

(73) Assignees: STATE GRID CORPORATION OF CHINA, Beijing (CN); CHINA ELECTRIC POWER RESEARCH INSTITUTE, Beijing (CN)

(21) Appl. No.: 13/391,562

(22) PCT Filed: Aug. 19, 2010
(86) PCT No.: PCT/CN10/01256

§ 371 Date: May 11, 2012

(30) Foreign Application Priority Data
Aug. 20, 2009 (CN) 200910168263.2

(51) Int. Cl. H02H 9/08

(52) U.S. Cl. 361/42

(57) ABSTRACT

A method and a device for limiting secondary arc current of an extra-high voltage/ultra-high voltage double circuit line on the same tower. The method comprises the following steps: determining the type of a single-phase-to-ground fault when the extra-high voltage/ultra-high voltage double circuit line on the same tower has a single-phase-to-ground fault (S501); selecting a reactance value of a neutral grounding reactor according to the type of the single-phase-to-ground fault (S502); and switching the extra-high voltage/ultra-high voltage double circuit line on the same tower to the selected reactance value of the neutral grounding reactor (S503). Thus the reactance value of the neutral grounding reactor is not constant, but is changed along with the operating conditions of the power transmission line, that is, the reactance value of the neutral grounding reactor is controllable. In this way, when the operating conditions of the extra-high voltage/ultra-high voltage double circuit line on the same tower are different, a neutral grounding reactor with an optimal reactance value can be selected so as to be accessed to the power transmission line, thereby effectively limiting the secondary arc current caused by the single-phase-to-ground fault.

### FIELD OF THE INVENTION

The present invention relates to the technical field of relay protection of an extra-high voltage/ultra-high voltage, and more specifically, to a method and device for limiting secondary arc current of an extra-high voltage/ultra-high voltage double-circuit line on the same tower.

### BACKGROUND OF THE INVENTION

According to operation experience of 220 kV and 500 kV power grid in China, single-phase-to-ground fault accounts for 80-90%, for which the success rate of single-phase reclosing is above 80%. Therefore, it has been proved in practical operations of 220 kV or above voltage level power grid that it is an important measure to widely employ single-phase reclosing technology for guaranteeing the safe and stable operation of power grid. Accordingly, single-phase reclosing technology has been also employed in our extra-high voltage/ultra-high voltage AC transmission systems.

However, when one phase of an extra-high voltage/ultra-high voltage circuit line is removed due to a single-phase-to-ground fault, because of coupling effect of interphase mutual inductance and interphase capacitance, a certain amount of ground current still flows at fault points in the removed fault phase, which is referred to as secondary arc current. Secondary arc current occurs in the form of electric arc, and thus is also referred to as secondary electric arc.

Referring to FIG. 1, FIG. 1 is a schematic diagram of secondary arc current of a power transmission line.

When a single-phase-to-ground fault (A phase) occurs in the line and after breakers at both ends of the fault phase are tripped, other two phases (B phase and C phase) operate continuously and maintain their operating voltages. Due to effect of interphase capacitance C₁₂ and interphase mutual inductance M, a current İ still flows through the fault point, which is the secondary arc current. Also, due to the effect of interphase capacitance and interphase mutual inductance, after the secondary arc current is extinguished, a recovery voltage \dot{U}_{A} presents between the original paths of the arc.

The larger the secondary arc current and the recovery voltage are, the harder the auto-extinguishing at the fault point is, leading to the failure of single-phase reclosing, and threatening the safety of power supply and the operation stability of the transmission system.

In our present extra-high voltage transmission systems, secondary arc current is mainly suppressed through providing high voltage shunt reactors (high voltage reactors, for short) to line and a neutral grounding reactor. Referring to FIG. 2, FIG. 2 is a schematic diagram of high voltage shunt reactors and a neutral grounding reactor. As shown in the figure, high voltage shunt reactor is represented by X_{L}, and a neutral grounding reactor is represented by X_{N}. Interphase capacitance and capacitance-to-ground of a power transmission line can be compensated through appropriately selecting the neutral grounding reactor, especially enabling approximately complete compensation between phases. Even for interphase reactance approaching to infinite, the capacitive component of secondary arc current can be reduced by the neutral grounding reactor; further, the inductive component of secondary arc current can be reduced by increasing reactance-to-ground.

Currently, small reactors with constant reactance values are generally employed in our extra-high voltage power transmission systems.

However, according to our plan of ultra-high voltage power grid, ultra-high voltage power transmission lines are generally in the form of double-circuit line on the same tower. The difficulty of extinguishing secondary arc current is increased therein due to coupling between two circuits.

Extra-high voltage/ultra-high voltage double-circuit lines on the same tower employ neutral grounding reactors with constant reactance values to suppress secondary arc current, for the main purpose of limiting secondary arc current during high-probability single-phase reclosing, enabling about 1s reclosing, nevertheless, with much larger secondary arc current and recovery voltage than single-circuit lines. On the other hand, with neutral grounding reactor having constant reactance values, larger secondary arc current may occur during same-phase or different-phase faults of the two circuits, in which cases whether about 1s reclosing can be met still needs to be verified.

### SUMMARY OF THE INVENTION

A method and device of limiting secondary arc current of an extra-high voltage/ultra-high voltage double-circuit line on the same tower are provided in this disclosure, which can limit secondary arc current of an extra-high voltage/ultra-high voltage double-circuit line on the same tower.

A method of limiting secondary arc current of an extra-high voltage/ultra-high voltage double-circuit line on the same tower is provided in one embodiment of this invention, comprising:

a determining step of determining the type of a single-phase-to-ground fault when a single-phase-to-ground fault occurs on the extra-high voltage/ultra-high voltage double-circuit line on the same tower;

a selecting step of selecting a reactance value of a neutral grounding reactor according to the type of the single-phase-to-ground fault;

a switching step of switching the extra-high voltage/ultra-high voltage double-circuit line on the same tower to the selected reactance value of the neutral grounding reactor.

Preferably, the determining step may comprise:

determining a fault phase of the extra-high voltage/ultra-high voltage double-circuit line on the same tower, on which the single-phase-to-ground fault occurs;

determining the type of the single-phase-to-ground fault according to the fault phase of the single-phase-to-ground fault and operation condition of the double-circuit line on the same tower.

Preferably, the selecting step may comprise:

after determining the type of the single-phase-to-ground fault, selecting a reactance value of a neutral grounding reactor corresponding to the type of the single-phase-to-ground fault, according to a pre-stored correspondence information between the types of single-phase-to-ground faults and the reactance values of the neutral grounding reactor.

Preferably, the method further comprises:

monitoring operation condition of the power transmission line at the sending end and receiving end of the extra-high voltage/ultra-high voltage double-circuit line on the same tower simultaneously, and when a single-phase-to-ground fault is detected firstly at one of the sending end and receiving end, transmitting single-phase-to-ground information to the other of the sending end and receiving end.

Preferably, the single-phase-to-ground fault information comprises at least one of a fault phase on which the single-phase-to-ground fault occurred, the type of the single-phase-to-ground fault and a selected reactance value of the neutral grounding reactor.

Preferably, after the switching step, the method further comprises:

after the single-phase-to-ground fault of the extra-high voltage/ultra-high voltage double-circuit line on the same tower has been settled, restoring the reactance value of the neutral grounding reactor to its original value in normal operation of the power transmission line.

A device of limiting secondary arc current of an extra-high voltage/ultra-high voltage double-circuit line on the same tower is further provided in one embodiment of the invention, comprising:

a fault type determining unit for determining the type of a single-phase-to-ground fault when the single-phase-to-ground fault occurs on the extra-high voltage/ultra-high voltage double-circuit line on the same tower;

a neutral grounding reactor selecting unit for selecting a reactance value of a neutral grounding reactor according to the type of the single-phase-to-ground fault;

a neutral grounding reactor switching unit for switching the extra-high voltage/ultra-high voltage double-circuit line on the same tower to the selected reactance value of the neutral grounding reactor.

Preferably, the device further comprises a line monitoring unit for monitoring operation condition of the extra-high voltage/ultra-high voltage double-circuit line on the same tower, and when a single-phase-to-ground fault occurred on the power transmission line has been detected, transmitting a fault signal to the fault type determining unit, which determines the type of the single-phase-to-ground fault, according to the fault signal.

Preferably, the device further comprises a neutral grounding reactor reactance resorting unit;

after the circuit line monitoring unit has detected the settlement of the single-phase-to-ground fault of the extra-high voltage/ultra-high voltage double-circuit line on the same tower, the neutral grounding reactor reactance resorting unit restores the reactance value of the neutral grounding reactor to its original value in the normal operation of the power transmission line.

Preferably, the fault type determining unit determines a fault phase of the extra-high voltage/ultra-high voltage double-circuit line on the same tower on which the single-phase-to-ground fault occurs, and determines the type of the single-phase-to-ground fault according to the fault phase of the single-phase-to-ground fault and operation condition of the double-circuit line on the same tower.

Preferably, the neutral grounding reactor selecting unit selects a reactance value of the neutral grounding reactor corresponding to the type of the single-phase-to-ground fault, according to pre-stored correspondence information between single-phase-to-ground fault types and reactance values of the neutral grounding reactor.

Preferably, the device of limiting secondary arc current of an extra-high voltage/ultra-high voltage double-circuit line on the same tower further comprises a single-phase-to-ground fault coordinating unit;

This device is disposed at the sending end and receiving end of the power transmission line respectively, and the devices disposed at the sending end and receiving end simultaneously monitor operation condition of the power transmission line.

When one of the device located at the sending end and the device located at the receiving end detects a single-phase-to-ground fault occurred on the power transmission line firstly, the single-phase-to-ground fault coordinating unit of the device that has detected the single-phase-to-ground fault on the power transmission line firstly transmits a single-phase-to-ground fault information to the single-phase-to-ground fault coordinating unit of the other one of the device located at the sending end and the device located at the receiving end.

Preferably, the single-phase-to-ground fault information comprises at least one of a fault phase on which the single-phase-to-ground fault occurred, the type of the single-phase-to-ground fault, and a selected reactance value of the neutral grounding reactor.

As compared to the prior art, the embodiments of the invention have the following advantages:

the method and device of limiting secondary arc current of an extra-high voltage/ultra-high voltage double-circuit line on the same tower, provided according to the embodiments of the invention, can determine the type of a single-phase-to-ground fault occurred on the extra-high voltage/ultra-high voltage double-circuit line on the same tower, select a corresponding reactance value of a neutral grounding reactor according to the type of the single-phase-to-ground fault, switch the extra-high voltage/ultra-high voltage double-circuit line on the same tower to the reactance value of the neutral grounding reactor corresponding to the type of the current fault. In so doing, a corresponding reactance value of the neutral grounding reactor can be selected according to the type of a single-phase-to-ground fault specifically occurred on a power transmission line. Consequently, the reactance value of the neutral grounding reactor is not constant, but can varies with operation condition of the power transmission line, that is, the reactance value of the neutral grounding reactor is controllable. Thus, when extra-high voltage/ultra-high voltage double-circuit line operates in different conditions, optimal reactance values can be selected for the neutral grounding reactor so as to be accessed to the power transmission line, limiting secondary arc current caused by the single-phase-to-ground fault.

### BRIEF DESCRIPTION OF THE DRAWINGS

FIG. 1 is a schematic diagram of secondary arc current of a power transmission line;

FIG. 2 is a schematic diagram of high voltage shunt reactors and a neutral grounding reactor;

FIG. 3 is a curve diagram of secondary arc current during single phase reclosing of the extra-high voltage/ultra-high voltage double transmission line on the same tower;

FIG. 4 is a curve diagram of recovery voltage during single phase reclosing of the extra-high voltage/ultra-high voltage double transmission line on the same tower;

FIG. 5 is a flowchart of a method according to a first embodiment of the invention;

FIG. 6 is a flowchart of a method according to a second embodiment of the invention;

FIG. 7 is a schematic diagram of limiting secondary arc current of an extra-high voltage/ultra-high voltage double-circuit line on the same tower;

FIG. 8 is a structural diagram of a device according to a first embodiment of the invention;

FIG. 9 is a structural diagram of a device according to a second embodiment of the invention; and

FIG. 10 is a structural diagram of a device according to a third embodiment of this invention.

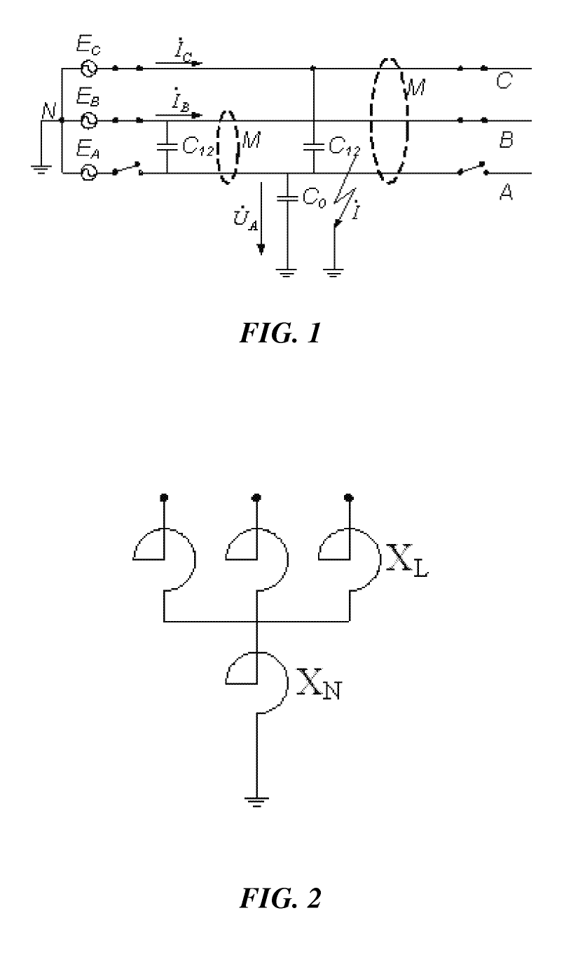

### DETAILED DESCRIPTION OF THE EMBODIMENTS

For better implementations of thE invention by those skilled in the art, at first, secondary arc current and recovery voltage when a single-phase-to-ground fault occurs under different operation conditions of an extra-high voltage/ultra-high voltage double transmission line on the same tower will be introduced, below.

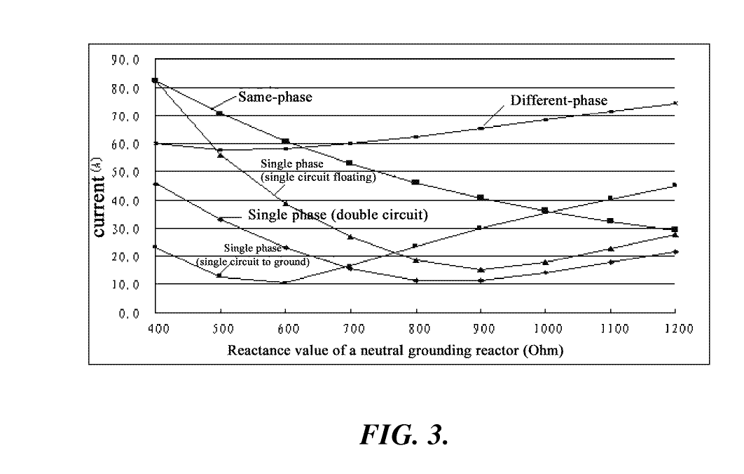

Referring to FIG. 3, FIG. 3 is a curve diagram of secondary arc current during single phase reclosing of an ultra-high voltage double transmission line on the same tower.

A 300-kilometer long power transmission line is selected for that extra-high voltage/ultra-high voltage double transmission line on the same tower, 720 Mvar high voltage shunt reactors are mounted on each end of the line.

The horizontal axis of the curve diagram represents reactance values of a neutral grounding reactor of the ultra-high voltage double transmission line on the same tower, in Ohm, and the longitudinal axis represents secondary arc current, in Ampere, caused in a single-phase-to-ground fault of the ultra-high voltage double-circuit line on the same tower.

There are five curves in FIG. 3, representing respectively: single phase (double-circuit) fault, single phase (single-circuit-to-ground) fault, single phase (single circuit floating) fault, same-phase fault and different-phase fault.

Single phase (double-circuit) fault: a fault that occurs when both circuits are operative;

Single phase (single-circuit-to-ground) fault: a single-phase-to-ground fault that occurs when one circuit is operative and the other one is grounded;

Single phase (single circuit floating) fault: a single-phase-to-ground fault that occurs when one circuit is operative and the other one is floating;

Same-phase fault: a same-phase to ground fault that occurs on both circuits when both of them are operative, for example, a line to ground fault occurs on both of the A phase of circuit 1 and the A phase of circuit 2.

Different-phase fault: a same-phase to ground fault that occurs on both circuits when both of them are operative, for example, a line to ground fault occur on both of the A phase of circuit 1 and the B phase of circuit 2.

It can be seen from FIG. 3 that different ground faults occurred on a double-circuit line on the same tower may correspond to different curves in FIG. 3. Further, when the neutral grounding reactor has different reactance values, the corresponding secondary arc currents are different too.

For example, for the single phase (single-circuit-to-ground) curve, when the neutral grounding reactor has a reactance value of 600Ω, the corresponding secondary arc current is minimized, in this case, of about 11 A. And for the single phase (double-circuit) curve, when the neutral grounding reactor has a reactance value of 900Ω, the corresponding secondary arc current is minimized, in this case, of about 12 A.

It can be seen from FIG. 3, when a different type of ground fault occurs on a power transmission line, there is a different reactance value of the neutral grounding reactor corresponding to minimal secondary arc current.

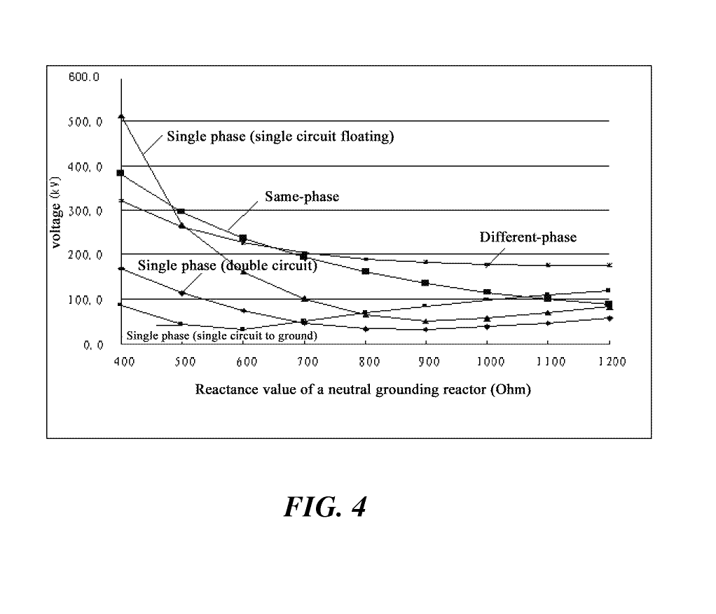

Referring to FIG. 4, FIG. 4 is a curve diagram of recovery voltage during single phase reclosing of an ultra-high voltage double-circuit line on the same tower.

Note that the line in FIG. 4 is the same as that of FIG. 3, merely except for the curve diagram of reactance values of neutral grounding reactors vs. recovery voltages.

It also can be seen from FIG. 4, for the single phase (single-circuit-to-ground) curve, when the neutral grounding reactor has a reactance value of 600Ω, the corresponding recovery voltage is minimized. For Single phase (double-circuit) curve, when the neutral grounding reactor has a reactance value of 900Ω, the corresponding recovery voltage is minimized.

It can be known from the above analysis, optimal reactance values required by the neutral grounding reactors are different under different fault conditions, based on which, a method of employing a controllable neutral grounding reactor is adopted in embodiments of the invention.

For a better understanding of the above objects, features and advantages of embodiments of the invention, some specific embodiments of the invention will be described in detail with reference to accompanying drawings below.

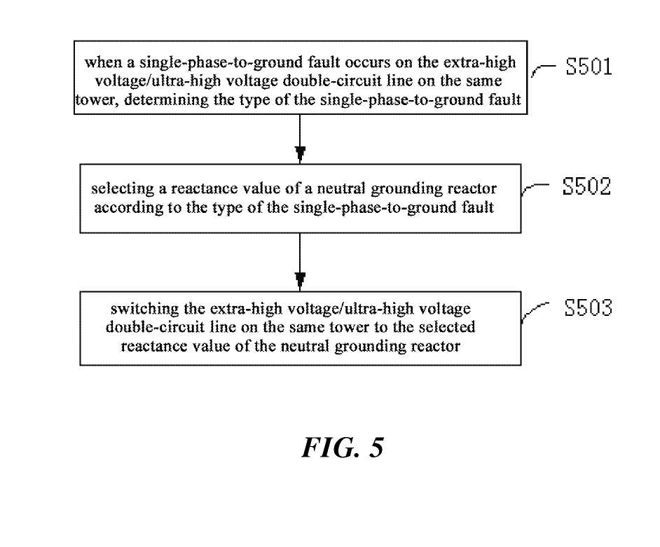

Referring to FIG. 5, FIG. 5 is a flowchart of a method according to a first embodiment of the invention.

A method of limiting secondary arc current of an extra-high voltage/ultra-high voltage double-circuit line on the same tower according to this embodiment comprises the following steps:

S501: determining the type of a single-phase-to-ground fault when the single-phase-to-ground fault occurs on the extra-high voltage/ultra-high voltage double-circuit line on the same tower.

As an implementation, a fault phase of the extra-high voltage/ultra-high voltage double-circuit line on the same tower on which the single-phase-to-ground fault occurs is determined, and then the type of the single-phase-to-ground fault is determined according to the fault phase on which the single-phase-to-ground fault occurs and operation condition of the double-circuit line on the same tower.

For example, there are five types of fault phases on which faults may occur: single phase (double-circuit) fault, single phase (single-circuit-to-ground) fault, single phase (single-circuit floating) fault, same-phase fault and different-phase fault.

S502: selecting a reactance value of a neutral grounding reactor according to the type of the single-phase-to-ground fault.

Different fault types may correspond to different optimal reactance values of the neutral grounding reactor. Thus, an optimal reactance value of the neutral grounding reactor will be selected according to the fault type.

As an implementation, reactance values of the neutral grounding reactor corresponding to various types of single-phase-to-ground faults are calculated in advance, to minimize the secondary arc current, and correspondence information between various types of single-phase-to-ground faults and reactance values of the neutral grounding reactors is stored; when the type of the single-phase-to-ground fault has been determined, a reactance value of the neutral grounding reactor corresponding to the type of the single-phase-to-ground fault is selected according to the correspondence information between the types of single-phase-to-ground faults and the reactance values of the neutral grounding reactor.

S503: switching the extra-high voltage/ultra-high voltage double-circuit line on the same tower to the selected reactance value of the neutral grounding reactor.

For example, when a single phase (single-circuit-to-ground) fault occurs on the power transmission line, the corresponding secondary arc current is minimized when the reactance value of the neutral grounding reactor is 600Ω, in that case, about 11 A. The neutral grounding reactor of the power transmission line is switched to 600Ω.

According to one embodiment of the method of the invention, operation condition of double-circuit line on the same tower is preset to: double-circuit powered on, single circuit floating, or single-circuit-to-ground. Protection systems on both ends of the line detect three-phase-line current through line CT scans respectively, and if only one phase has different current intensities at its opposite ends, it is determined that a single-phase-to-ground fault occurs on that phase of this line. When operation condition of the double-circuit line on the same tower is single-circuit-to-ground or single-circuit floating, it is determined that the type of the single-phase-to-ground fault is single phase (single circuit-to-ground) fault or single phase (single-circuit floating) fault; when operation condition of the double-circuit line on the same tower is double-circuit powered on, if the single-phase-to-ground fault only occurs on one circuit, it is determined that the type of the single-phase-to-ground fault is single phase (double-circuit) fault; if the single-phase-to-ground fault occurs on both circuits, the type of single-phase-to-ground fault can be determined as a same-phase fault or a different-phase fault, according to whether fault phases of the two circuits on which the single-phase-to-ground fault occurs are the same. The reactance value of the neutral grounding reactor is determined according to the type of the single-phase-to-ground fault.

The method of limiting secondary arc current of an extra-high voltage/ultra-high voltage double-circuit line on the same tower according to the embodiments of this invention can determine the type of a single-phase-to-ground fault occurred on the extra-high voltage/ultra-high voltage double-circuit line on the same tower, select a corresponding reactance value of a neutral grounding reactor according to the type of the single-phase-to-ground fault, and switch the extra-high voltage/ultra-high voltage double-circuit line on the same tower to the reactance value of the neutral grounding reactor corresponding to the type of the current fault. In so doing, a corresponding reactance value of the neutral grounding reactor can be selected according to the type of a single-phase-to-ground fault specifically occurred on the power transmission line. Consequently, the reactance value of the neutral grounding reactor is not constant, but can varies with operation condition of the power transmission line, that is, the reactance value of the neutral grounding reactor is controllable. Thus, when an extra-high voltage/ultra-high voltage double-circuit line operates in different conditions, optimal reactance values can be selected for the neutral grounding reactor so as to be accessed to the power transmission line, limiting secondary arc current caused by the single-phase-to-ground fault.

Referring to Table 1, Table 1 shows the secondary arc current of an ultra-high voltage double-circuit line on the same tower using controllable reactor.

| | Secondary arc | | |
|---|---|---|---|
| | current when | Secondary arc | |
| | using a neutral | current when | |
| | grounding | using a | |
| | reactor having | controllable | Decrease of |
| | a constant | neutral | secondary |
| Operation manner and | reactance | grounding | arc |
| fault type | value of 700 Ω | reactor | current (%) |
| (double-circuit powered | 15.7 | 11.3 (900 Ω) | 28% |
| on) single phase fault | | | |
| One-circuit-powered-off | 16.5 | 10.3 (600 Ω) | 38% |
| (grounded) | | | |
| one-circuit-powered-on | | | |
| single phase fault | | | |
| One-circuit-powered-off | 26.7 | 14.0 (900 Ω) | 48% |
| (floating) | | | |
| one-circuit-powered-on | | | |
| single phase fault | | | |
| Double-circuit-powered- | 52.8 | 29.4 (1200 Ω) | 44% |
| on same-phase fault | | | |
| Double-circuit-powered- | 59.9 | 57.7 (500 Ω) | 4% |
| on different-phase fault | | | |

It can be seen from Table 1, different reactance values are required for the neutral grounding reactor in the case of different transmission-line operation conditions and fault types, that is to say, the reactance value of the neutral grounding reactor is variable. As compared to neutral grounding reactor with a constant reactance value (700Ω) in the prior art, the controllable neutral grounding reactor provided in the embodiment of this invention can effectively limit secondary arc current. The last column of Table 1 shows percentile drops of secondary arc current of controllable neutral grounding reactors as compared to a neutral grounding reactor with a constant reactance value (700Ω). It can be seen that except for the double-circuit-powered-on and different-phase fault, secondary arc current is significantly suppressed in other four fault types. The time of reclosing can be shortened due to decreased secondary arc current. Thus, rapid reclosing may be achieved when a single-phase-to-ground fault occurs.

It should be noted that, for different specific power transmission lines, different optimal reactance values are required for neutral grounding reactors when a same type of single-phase-to-ground faults occur. In table 1, reactance values of 900Ω, 600Ω, 900Ω, 1200Ω and 500Ω are shown for those five fault types, which are specifically selected for a 300 kilometer long ultra-high voltage double-circuit power transmission line on the same tower, with 720 Mvar high voltage shunt reactors disposed on both ends of the line. The reactance value of the neutral grounding reactor can be selected according to practical line conditions for other types of power transmission lines.

For a specific power transmission line, the secondary arc current and its recovery voltage are calculated for different reactance values of the neutral grounding reactor and different fault conditions, based on fundamental data, such as system operation manner, tide flow, conductors of the line, pole/tower, transposition, the degree of high-voltage reactor compensation. Based on the calculation result, an optimal reactance value of the neutral grounding reactor is selected.

For example, with respect to the correspondence between secondary arc currents and recovery voltages during reclosing and reactance values of the controllable neutral grounding reactor, as shown in FIGS. 3, 4, the reactance values of the neutral grounding reactors have an adjustable range of 500Ω˜1200Ω, the reactance adjustment gradient is not larger than 100Ω, and the time of reactance adjustment is not more than 100 ms.

According to requirements about the variable range of reactance values of the neutral grounding reactor, reactance adjustment gradient, adjustment rate, insulating level, etc described above, a suitable reactor with a controllable reactance value can be selected.

There is not any particular limiting on principles and structures of reactance controllable reactors, for example: reactors with taps serving for online adjustment of taps, or controllable reactors having a continuous or stepped reactance adjustment function can be adopted, such as magnetic valve or high impedance transformer type controllable reactors. Taking a reactor having taps that can be adjusted online as an example, the reactor has several taps on its low voltage side, any one of those taps can be adjusted to be connected to ground online, and different taps correspond to different reactance values of the reactor, so as to realize the online adjustment of the reactance value of the neutral grounding reactor.

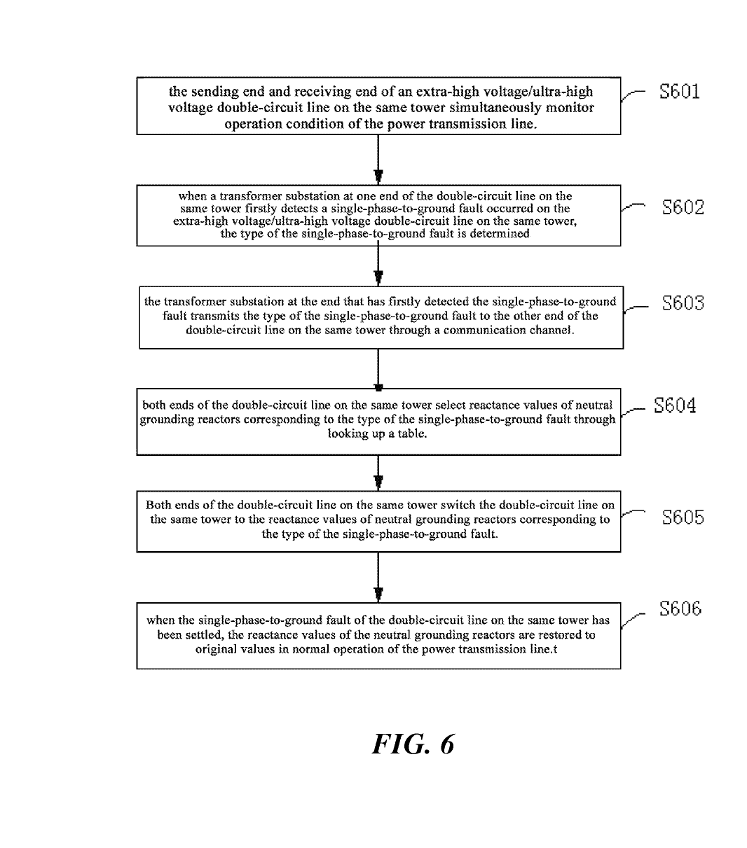

Operating condition of a power transmission line can be monitored simultaneously at the sending end and the receiving end of the extra-high voltage/ultra-high voltage double-circuit line on the same tower. When a single-phase-to-ground fault occurs on the power transmission line, a transformer substation at one end may detect the fault very quickly, while a transformer substation at the other end may get a slower detection of fault. In one embodiment of the invention, a coordinating function of the reactance value is added for neutral grounding reactors at both of the sending end and the receiving end of the extra-high voltage/ultra-high voltage double-circuit line on the same tower, thus when one end detects a fault before the other end, the transformer substation at that end that detected the fault firstly may, through a communication channel (for example, communication fiber, etc.) between the transformer substations at the sending end and the receiving end, notify the transformer substation at the other end of the power transmission line of this fault, so that the reliability and speed of reactance selection can be improved for neutral grounding reactors. For example, operation condition of the power transmission line is monitored at both of the sending end and the receiving end of the extra-high voltage/ultra-high voltage double-circuit line on the same tower simultaneously, when any one of the sending end and the receiving end has detected a single-phase-to-ground fault of the power transmission line, it transmits information about the single-phase-to-ground fault (e.g., at least one of a fault phase on which the fault occurred, the type of the single-phase-to-ground fault, and a selected reactance value of the neutral grounding reactor) to the other end of the sending end and the receiving end, so that the reactance switching process can be carried out as quickly as possible for the neutral grounding reactor at the other end, improving the reliability and speed of reactance selection for that neutral grounding reactor. A specific implementation of the embodiment will be discussed with reference to FIG. 6 below.

Referring to FIG. 6, FIG. 6 is a flowchart of the method according to a second embodiment of the invention.

S601: the sending end and receiving end of an extra-high voltage/ultra-high voltage double-circuit line on the same tower simultaneously monitor operation condition of the power transmission line.

S602: when a transformer substation at one end of the double-circuit line on the same tower firstly detects a single-phase-to-ground fault occurred on the extra-high voltage/ultra-high voltage double-circuit line on the same tower, the type of the single-phase-to-ground fault is determined;

S603: the transformer substation at one end that has firstly detected the single-phase-to-ground fault transmits the type of the single-phase-to-ground fault to the other end of the double-circuit line on the same tower through a communication channel.

S604: both ends of the double-circuit line on the same tower select reactance values of neutral grounding reactors corresponding to the type of the single-phase-to-ground fault through looking up a table, according to the type of the single-phase-to-ground fault, respectively.

For example, a particular implementation of the lookup method comprises: calculating optimal reactance values of a neutral grounding reactor corresponding to various types of single-phase-to-ground faults in advance, the optimal reactance values of the neutral grounding reactor minimizes the secondary arc current caused when those types of single-phase-to-ground faults occur, then storing information of various single-phase-to-ground fault types and corresponding reactance values of the neutral grounding reactor in a table; when the type of a single-phase-to-ground fault is determined, a reactance value of the neutral grounding reactor corresponding to the type of the single-phase-to-ground fault is selected through looking up the table.

S605: Both ends of the double-circuit line on the same tower switch the extra-high voltage/ultra-high voltage double-circuit line on the same tower to the reactance values of neutral grounding reactors corresponding to the type of the single-phase-to-ground fault.

S606: when the single-phase-to-ground fault of the extra-high voltage/ultra-high voltage double-circuit line on the same tower has been settled, the reactance values of the neutral grounding reactors are restored to their original values in normal operation of the power transmission line.

It should be noted that, in the above embodiment, a transformer substation at one end that has firstly detected a single-phase-to-ground fault transmits the type of the single-phase-to-ground fault that has been determined to the other end, for coordinating controls on both ends, so that the reliability and speed of reactance value selection can be improved for neutral grounding reactors. Those skilled in the art should appreciate that the transformer substation at one end that has firstly detected a single-phase-to-ground fault also may send a fault phase on which the single-phase-to-ground fault occurs or a selected reactance value of the neutral grounding reactor to the other end, for the subsequent process at that end, which may also achieve the same purpose as that of the above embodiment.

A neutral grounding reactor does not function in stable operation of a power transmission line, at that time, the reactance of the neutral grounding reactor can be set to an original value. The reactance of the neutral grounding reactor can be adjusted to its original value upon successful single phase reclosing.

The method provided in the embodiment of the invention can dynamically adjust the reactance value of a neutral grounding reactor according to the type of a power transmission line fault, and the reactance value of the neutral grounding reactor can always be adjusted to an optimal value for limiting the secondary arc current of that fault type, regardless of the type of the single-phase-to-ground fault, mostly exerting its effect on accelerating the extinguishing of secondary arc current.

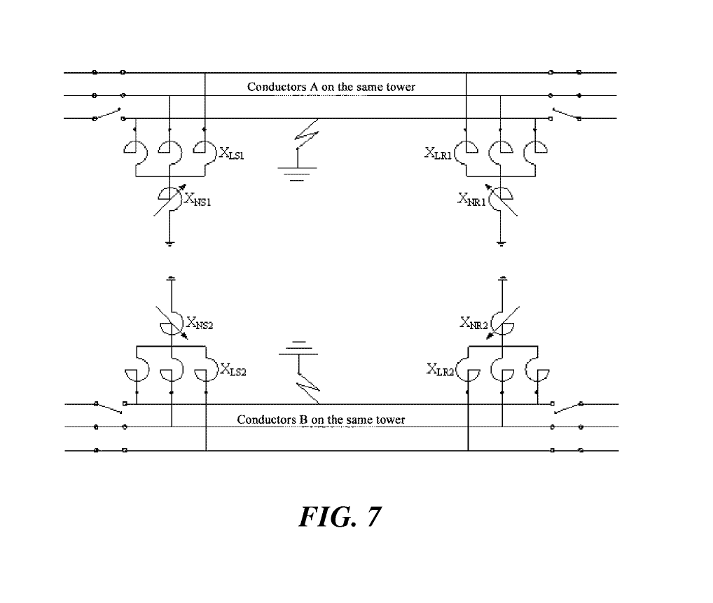

Referring to FIG. 7, FIG. 7 is a schematic diagram of limiting secondary arc current of an extra-high voltage/ultra-high voltage double-circuit line on the same tower according to one embodiment of this invention.

The extra-high voltage/ultra-high voltage double-circuit line on the same tower comprises conductors A and conductors B on the same tower.

Either conductors A or conductors B on the same tower have high-voltage shunt reactors and neutral grounding reactors disposed on both their ends.

High-voltage shunt reactors X_{LS1} and a controllable neutral grounding reactor X_{NS1} are mounted on the sending end of conductors A on the same tower; high-voltage shunt reactors X_{LR1} and a controllable neutral grounding reactor X_{NR1} are mounted on the receiving end of conductors A on the same tower.

High-voltage shunt reactors X_{LS2} and a controllable neutral grounding reactor X_{NS2} are mounted on the sending end of conductors B on the same tower; high-voltage shunt reactors X_{LR2} and a controllable neutral grounding reactor X_{NR2} are mounted on the receiving end of conductors B on the same tower.

Each group of high-voltage shunt reactors is coupled to the three phases of power transmission line in parallel; each controllable neutral grounding reactor has its one end connected to the high-voltage shunt reactors in series, and other end grounded.

When a single-phase-to-ground fault occurs on the power transmission line, a corresponding optimal reactance value of the neutral grounding reactor can be selected according to the type of the fault, and the controllable neutral grounding reactor can be adjusted to the reactance value that is currently required.

A device of limiting secondary arc current of an extra-high voltage/ultra-high voltage double-circuit line on the same tower, as shown in FIG. 7, for example, is also provided in one embodiment of this invention, as discussed below in connection with a particular embodiment.

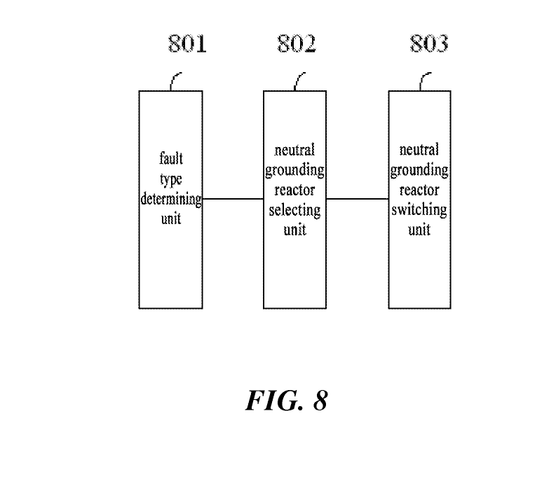

Referring to FIG. 8, FIG. 8 is a structural diagram of a device according to a first embodiment of device of the invention.

The device of limiting secondary arc current of an extra-high voltage/ultra-high voltage double-circuit line on the same tower provided in this embodiment comprises: a fault type determining unit 801, a neutral grounding reactor selecting unit 802, and a neutral grounding reactor switching unit 803.

When a single-phase-to-ground fault occurs on an extra-high voltage/ultra-high voltage double-circuit line on the same tower, the fault type determining unit 801 determines the type of the single-phase-to-ground fault.

For example, there are five types of fault phases on which a fault may occur: single phase (double-circuit) fault, single phase (single-circuit grounded) fault, single phase (single-circuit floating) fault, same-phase fault, and different-phase fault.

The neutral grounding reactor selecting unit 802 selects a reactance value of a neutral grounding reactor according to the type of the single-phase-to-ground fault.

One implementation of selecting a reactance value of a neutral grounding reactor according to the type of the single-phase-to-ground fault by the neutral grounding reactor selecting unit 802 comprises: finding a reactance value of the neutral grounding reactor corresponding to the type of the single-phase-to-ground fault through looking up a table by the neutral grounding reactor selecting unit. For example, the neutral grounding reactor selecting unit may select a reactance value of the neutral grounding reactor corresponding to the type of the single-phase-to-ground fault, according to pre-stored information about the correspondence between types of single-phase-to-ground faults and reactance values of the neutral grounding reactors.

The neutral grounding reactor switching unit 803 switches the extra-high voltage/ultra-high voltage double-circuit line on the same tower to the reactance value of the neutral grounding reactor corresponding to the type of the single-phase-to-ground fault.

The device of limiting secondary arc current of an extra-high voltage/ultra-high voltage double-circuit line on the same tower provided in the embodiments of the invention can determine the type of a single-phase-to-ground fault occurred on the extra-high voltage/ultra-high voltage double-circuit line on the same tower, select a corresponding reactance value of a neutral grounding reactor according to the type of the single-phase-to-ground fault, switch the extra-high voltage/ultra-high voltage double-circuit line on the same tower to the reactance value of the neutral grounding reactor corresponding to the type of the current fault. In so doing, a corresponding reactance value of the neutral grounding reactor can be selected according to the type of a single-phase-to-ground fault specifically occurred on power transmission lines. Consequently, the reactance value of the neutral grounding reactor is not constant, but can varies with operation condition of power transmission lines, that is, the reactance value of the neutral grounding reactor is controllable. Thus, when extra-high voltage/ultra-high voltage double-circuit line operates in different conditions, optimal reactance values can be selected for the neutral grounding reactor so as to be accessed to the power transmission lines, limiting secondary arc current caused by the single-phase-to-ground fault, consequently.

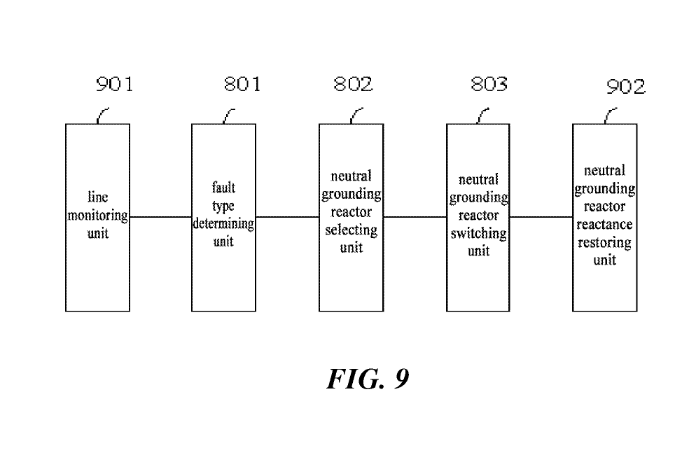

Referring to FIG. 9, FIG. 9 is a structural diagram of a device according to a second embodiment of device of the invention.

The device of limiting secondary arc current of an extra-high voltage/ultra-high voltage double-circuit line on the same tower provided in the present embodiment differs from the first embodiment in a line monitoring unit 901 that is added. The line monitoring unit 901 monitors operating condition of the extra-high voltage/ultra-high voltage double-circuit line on the same tower, when detecting a single-phase-to-ground fault occurred on the power transmission line, transmits a fault signal to the fault type determining unit 801, which receives the fault signal and then determines the type of the single-phase-to-ground according to the fault signal.

Optionally, the embodiment may further comprise a neutral grounding reactor reactance restoring unit 902.

After the line monitoring unit 901 detects the settlement of the single-phase-to-ground fault of the extra-high voltage/ultra-high voltage double-circuit line on the same tower, the neutral grounding reactor reactance restoring unit 902 restores the reactance value of the neutral grounding reactor to its original value for the normal operation of the power transmission line.

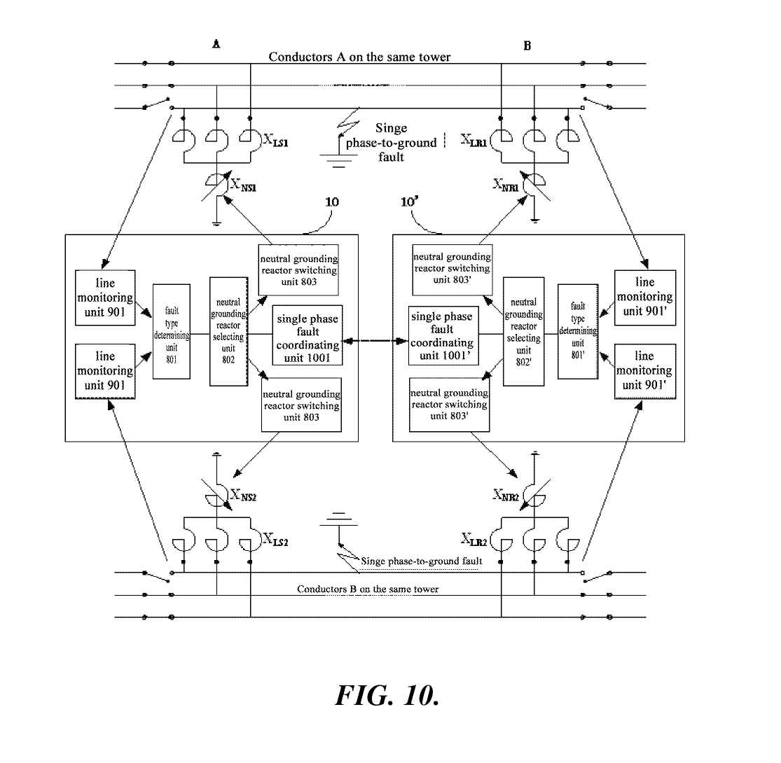

Referring to FIG. 10, FIG. 10 is a structural diagram of a device according to a third embodiment of device of the invention.

In this embodiment, a device 10 and 10′ for limiting secondary arc current of an extra-high voltage/ultra-high voltage double-circuit line on the same tower are provided respectively at the sending end A and receiving end B of the extra-high voltage/ultra-high voltage double-circuit line on the same tower, for monitoring the operating condition of the power transmission line simultaneously.

The devices 10, 10′ for limiting secondary arc current of an extra-high voltage/ultra-high voltage double-circuit line on the same tower comprise single phase fault coordinating units 1001, 1001′ respectively. The single phase fault coordinating units 1001, 1001′ communicate with each other through a communication channel. When the device at one of the sending end A and receiving end B, for example, the device 10 at the sending end A has firstly detected a single-phase-to-ground fault occurred on the power transmission line, the single phase fault coordinating unit 1001 of the device 10 transmits the single-phase-to-ground information received from the fault type determining unit 801 or neutral grounding reactor selecting unit 802 to the single phase fault coordinating unit 1001′ of the device 10′ at the receiving end B. The single phase fault coordinating unit 1001′ of the device 10′ at the receiving end B receives the single-phase-to-ground information from the sending end A, sends it to the fault type determining unit 801′ or neutral grounding reactor selecting unit 802′, and carries out the reactance switching process of the neutral grounding reactor.

The single-phase-to-ground fault information comprises at least one of a fault phase on which the single-phase-to-ground fault occurred the type of the single-phase-to-ground fault, and a selected reactance value of the neutral grounding reactor. For example, the single phase fault coordinating unit 1001 is coupled to the neutral grounding reactor switching unit 803, when a single-phase-to-ground fault occurred on the power transmission line is detected by the line monitoring unit 901, the neutral grounding reactor selecting unit 802, through the single phase fault coordinating unit 1001, transmits the type of the single-phase-to-ground fault and/or the selected reactance value of the neutral grounding reactor to the single phase fault coordinating unit 1001′, which sends the received type of the single-phase-to-ground fault and/or selected reactance value of the neutral grounding reactor to the neutral grounding reactor selecting unit 802′, and the neutral grounding reactor selecting unit 802′ controls the neutral grounding reactor switching unit 803′ to switch the reactance value of the neutral grounding reactor.

It should be noted that the line monitoring units 901, 901′ and the neutral grounding reactor switching units 803, 803′ are shown in FIG. 10 as two independent modules respectively. It will be appreciated by those skilled in the art, however, the line monitoring units 901, 901′ and the neutral grounding reactor switching units 803, 803′ can be realized in single module(s) for processing line monitoring and reactor switching of both circuits.

The device provided in the embodiment of the invention can dynamically adjust the reactance value of a neutral grounding reactor according to the type of a power transmission line fault, and the reactance value of the neutral grounding reactor can always be adjusted to an optimal value for limiting the secondary arc current of that fault type, regardless of the type of the single-phase-to-ground fault, best exerting its effect on accelerating the extinguishing of secondary arc current.

Those skilled in the art may understand that modules or steps described in connection with block diagrams and steps of this disclosure are merely illustrative, and any combination of those modules and steps can be made according to requirements of particular implementations. Furthermore, those modules and steps can be realized through software, hardware on which computer instruments execute, or specialized circuits etc.

Those skilled in the art may understand that all or parts of method steps of the above embodiments can be implemented by hardware relevant to program instruments, which can be stored in a computer readable storage medium, when executing the program, executes the steps including the above method embodiments; the above storage medium comprises: ROM, RAM, magnetic disk or optical disk etc., and any other medium, on which program code can be stored.

The description above is merely some preferable embodiments of this invention, and is any way not limiting to this invention. Although some preferable embodiments of this invention have been disclosed above, they are not limiting to this invention. Any skilled in the art may make many changes and modifications or equivalents of technical solution of this invention through utilizing the methods and technical content disclosed above without departing from the scope of this invention. Thus, any simple changes, equivalents, or modifications to the above embodiments according to the subject matter of this invention fall within the protection scope of this invention, as not departing from the content of the technical solution of this invention.

What is claimed is:

1. A method of limiting secondary arc current of an extra-high voltage/ultra-high voltage double-circuit line on the same tower, characterized in comprising:
a determining step of determining the type of a single-phase-to-ground fault when the single-phase-to-ground fault occurs on the extra-high voltage/ultra-high voltage double-circuit line on the same tower;
a selecting step of selecting a reactance value of a neutral grounding reactor according to the type of the single-phase-to-ground fault;
a switching step of switching the extra-high voltage/ultra-high voltage double-circuit line on the same tower to the selected reactance value of the neutral grounding reactor.

2. The method of limiting secondary arc current of an extra-high voltage/ultra-high voltage double-circuit line on the same tower according to claim 1, characterized in that the determining step comprises:
determining a fault phase of the extra-high voltage/ultra-high voltage double-circuit line on the same tower, on which the single-phase-to-ground fault occurs;
determining the type of the single-phase-to-ground fault according to the fault phase of the single-phase-to-ground fault and operation condition of the double-circuit line on the same tower.

3. The method of limiting secondary arc current of an extra-high voltage/ultra-high voltage double-circuit line on the same tower according to claim 1, characterized in that the selecting step comprises:
selecting a reactance value of a neutral grounding reactor corresponding to the type of the single-phase-to-ground fault, according to pre-stored correspondence information between types of single-phase-to-ground faults and reactance values of the neutral grounding reactors.

4. The method of limiting secondary arc current of an extra-high voltage/ultra-high voltage double-circuit line on the same tower according to claim 1, characterized in further comprising:
monitoring operation condition of the power transmission line at the sending end and receiving end of the extra-high voltage/ultra-high voltage double-circuit line on the same tower simultaneously, and when a single-phase-to-ground fault is detected firstly at one of the sending end and receiving end, transmitting single-phase-to-ground information to the other of the sending end and receiving end.

5. The method of limiting secondary arc current of an extra-high voltage/ultra-high voltage double-circuit line on the same tower according to claim 4, characterized in that the single-phase-to-ground fault information comprises at least one of a fault phase on which the single-phase-to-ground fault occurred, the type of the single-phase-to-ground fault, and a selected reactance value of the neutral grounding reactor.

6. The method of limiting secondary arc current of an extra-high voltage/ultra-high voltage double-circuit line on the same tower according to claim 1, characterized in further comprising:
after the single-phase-to-ground fault of the extra-high voltage/ultra-high voltage double-circuit line on the same tower has been settled, restoring the reactance value of the neutral grounding reactor to its original value in normal operation of the power transmission line.

7. A device of limiting secondary arc current of an extra-high voltage/ultra-high voltage double-circuit line on the same tower, characterized in comprising:
a fault type determining unit for determining the type of a single-phase-to-ground fault when the single-phase-to-ground fault occurs on the extra-high voltage/ultra-high voltage double-circuit line on the same tower;
a neutral grounding reactor selecting unit for selecting a reactance value of a neutral grounding reactor according to the type of the single-phase-to-ground fault;
a neutral grounding reactor switching unit for switching the extra-high voltage/ultra-high voltage double-circuit line on the same tower to the selected reactance value of the neutral grounding reactor.

8. The device of limiting secondary arc current of an extra-high voltage/ultra-high voltage double-circuit line on the same tower according to claim 7, characterized in further comprising:
a line monitoring unit for monitoring operation condition of the extra-high voltage/ultra-high voltage double-circuit line on the same tower, and when a single-phase-to-ground fault occurred on the power transmission line has been detected, transmitting a fault signal to the fault type determining unit;
the fault type determining unit determining the type of the single-phase-to-ground fault according to the fault signal.

9. The device of limiting secondary arc current of an extra-high voltage/ultra-high voltage double-circuit line on the same tower according to claim 8, characterized in further comprising:
a neutral grounding reactor reactance resorting unit restoring the reactance value of the neutral grounding reactor to its original value in normal operation of the power transmission line for after the circuit line monitoring unit has detected the settlement of the single-phase-to-ground fault of the power transmission line.

10. The device of limiting secondary arc current of an extra-high voltage/ultra-high voltage double-circuit line on the same tower according to claim 7, characterized in that the fault type determining unit determines a fault phase of the extra-high voltage/ultra-high voltage double-circuit line on the same tower on which the single-phase-to-ground fault occurs, and determines the type of the single-phase-to-ground fault according to the fault phase of the single-phase-to-ground fault and operation condition of the double-circuit line on the same tower.

11. The device of limiting secondary arc current of an extra-high voltage/ultra-high voltage double-circuit line on the same tower according to claim 7, characterized in that the neutral grounding reactor selecting unit selects a reactance value of the neutral grounding reactor corresponding to the type of the single-phase-to-ground fault, according to pre-stored correspondence information between the single-phase-to-ground fault types and reactance values of the neutral grounding reactors.

12. The device of limiting secondary arc current of an extra-high voltage/ultra-high voltage double-circuit line on the same tower according to claim 7, characterized in that the device further comprises a single-phase-to-ground fault coordinating unit; wherein
the device is disposed at each of the sending end and receiving end of the power transmission line, and the devices disposed at the sending end and receiving end simultaneously monitor operation condition of the power transmission line;
when one of the device located at the sending end and the device located at the receiving end detects a single-phase-to-ground fault occurred on the power transmission line firstly, the single-phase-to-ground fault coordinating unit of the device that has firstly detected the single-phase-to-ground fault on the power transmission line transmits a single-phase-to-ground fault information to the single-phase-to-ground fault coordinating unit of the other one of the device located at the sending end and the device located at the receiving end.

13. The device of limiting secondary arc current of an extra-high voltage/ultra-high voltage double-circuit line on the same tower according to claim 12, characterized in that the single-phase-to-ground fault information comprises at least one of a fault phase on which the single-phase-to-ground fault occurred, the type of the single-phase-to-ground fault, and a selected reactance value of the neutral grounding reactor.
